(19) United States
(12) Patent Application Publication
(10) Pub. No.: US 2013/0294669 A1
(43) Pub. Date: Nov. 7, 2013

(54) SPATIAL-SPECTRAL ANALYSIS BY AUGMENTED MODELING OF 3D IMAGE APPEARANCE CHARACTERISTICS WITH APPLICATION TO RADIO FREQUENCY TAGGED CARDIOVASCULAR MAGNETIC RESONANCE

(71) Applicant: UNIVERSITY OF LOUISVILLE RESEARCH FOUNDATION, INC., Louisville, KY (US)

(72) Inventors: Ayman S. El-Baz, Louisville, KY (US); Matthew Nitzken, Louisville, KY (US); Garth M. Beache, Louisville, KY (US)

(73) Assignee: UNIVERSITY OF LOUISVILLE RESEARCH FOUNDATION, INC., Louisville, KY (US)

(21) Appl. No.: 13/834,304

(22) Filed: Mar. 15, 2013

Related U.S. Application Data
(60) Provisional application No. 61/641,598, filed on May 2, 2012.

(51) Int. Cl. G06T 7/00

(52) U.S. Cl. CPC G06T 7/0012
USPC 382/131

(57) ABSTRACT

A computer aided image processing system and automated method to improve tagged magnetic resonance image data through modeling and analyzing the magnetic resonance image data using a linear combination of discrete Gaussians model and using a Markov-Gibbs random field model. The processed magnetic resonance images include reduced noise associated with the tags, augmented gradients across a tag profile and an amplified tag to background contrast as compared to the original tagged magnetic resonance images.

### CROSS-REFERENCE TO RELATED APPLICATIONS

This application is a continuation of U.S. Provisional Application No. 61/641,598, filed on May 2, 2012 by Ayman El-Baz et al., the entire disclosure of which is incorporated by reference herein.

### FIELD OF THE INVENTION

The invention is generally related to computer analysis of medical image data, and in particular to the analysis of cardiovascular medical images.

### BACKGROUND OF THE INVENTION

Tagged Cardiac Magnetic Resonance imaging (CMR) is a technique for detailed and non-invasive visualization of myocardium motion and deformation, with full 3D spatial geometric concordance. Local diseases, such as coronary atherosclerosis, as well as global diseases, such as heart failure and diabetes, result in wall dysfunction that manifests on tagged images. Magnetic Resonance (MR) tagging places a pre-specified pattern of virtual temporary markers (called tags) inside soft body tissues such that tag lines are created by patterns of magnetic spin in the examined tissue, and motion in the tagged tissue can be measured from the images. This technique complements traditional anatomical images and can capture detailed information about the heart over time. The tag lines allow for the computation of displacement, velocity, rotation, elongation, strain, and twist of the heart. While traditional MR techniques carry only information about the motion at the boundaries of an object, the tag lines facilitate examination of the strain and displacement of the tissue interior in close detail.

Methods for analyzing tagged MR images generally fall into the two broad spatial and spectral (frequency domain) categories. Spatial analysis estimates tissue motion and strain by identifying spatial locations of the tag lines in an image and using either model-based or model-free interpolation and differentiation. Because spatial methods track actual pixels throughout the image, these methods generally require substantial image preprocessing and segmentation, and are often computationally expensive.

Spectral analysis analyzes the harmonic phases of material points, where such material points generally do not change with motion. Because the material points generally do not change with motion, spectral analysis may build a tissue motion field. Spectral analysis methods generally perform faster as compared to spatial analysis methods, and in many cases, following a points' harmonic movement provides a more accurate tracking method as compared to spatial analysis methods.

One conventional spectral analysis method utilized in analyzing CMR images utilizes a Harmonic Phase (HARP) method. The HARP method typically computes phase images from sinusoidal tagged MR images by bandpass filtering in the Fourier domain. The MR images have both a spatial and a spectral representation (by Fourier transform). Furthermore, sharp lines in the spatial domain generally relate to noisy peaks in the spectral domain, and conversely smooth lines in the spatial domain relate to sharp peaks in the spectral domain. Therefore, spatial noise and corruption can notably affect spectral image analysis.

In general, spectral based tracking methods assume that points found in a tissue do not move a significant distance between two successive time frames. However, if the tissue in the area being tracked has a low temporal resolution or a high rate of movement, or if the MR tag parameters are selected incorrectly, corruption and noise may be introduced in the acquired images. The introduction of corruption may cause the points to be difficult to track, and the assumption that the points found in a tissue do not move much from one time frame to the next may appear to be violated. The corruption and noise may lead to spectral analysis methods failing to accurately track the tissue. In general, the primary causes of corruption and spectral based tracking failures may be classified into three types of causes: a high rate of motion between two successive frames, a through-plane motion, and boundary point tracking.

Errors due to a high rate of motion between two successive frames can be corrected by either improving the temporal resolution or decreasing the spatial frequency, or periodicity, of the tags. However, an increased temporal resolution generally reduces the overall image spatial resolution, and furthermore, decreasing the tag frequency may reduce the accuracy of spectral phase estimation. Through-plane motion errors typically appear because a material point is initially defined for the first time frame and is subsequently tracked through the remaining time series images. Points may disappear and reappear along the series of images, and this can make spectral tracking algorithms assume incorrect locations of points. In addition, boundary points being tracked near the edge may be shifted out of the tissue in subsequent frames due to noise or corruption. Spectral tracking failures that result from noise and data corruption, may require a user to manually identify and correct mistracked points. In some cases manual adjustments may be required for multiple data points in every image in a sequence. Such manual identification may be very time-consuming, especially in studies or clinical examinations when large numbers of data points must be tracked.

Therefore, a need continues to exist in the art for improved image processing systems and methods for use in analyzing magnetic resonance medical images.

### SUMMARY OF THE INVENTION

The invention addresses these and other problems associated with the prior art by providing a computer aided processing system and automated method for processing tagged magnetic resonance (MR) images to generate improved tagged images in the spectral domain. Embodiments of the invention may process MR images to generate improved tagged images including reduced noise across one or more tag lines, augmented gradients across a tag profile, and/or amplified tag-to-background contrast. Embodiments of the invention may process Cardiac Magnetic Resonance (CMR) images modeling a distribution of CMR signals for the images corresponding to a cardiac cycle with an adaptive linear combination of discrete Gaussians (LCDG), where such modeled signals may be separated into signals corresponding to tag lines and signals corresponding to background. In addition, the images may be modeled by analyzing the images using a translation/rotation-invariant three-dimensional (3D) Markov-Gibbs random field model, where the images may be modeled by considering the CMR signals as voxel signals with multiple pairwise spatiotemporal (in-plane space and time) interactions. The gray-level signal of voxel-wise pairs may be analyzed to determine Gibbs potentials for interacting voxel pairs in the image set. A three-dimensional energy function may be determined based at least in part on the interaction of the voxel pairs and the determined Gibbs potentials. The energy function may be utilized to amplify homogeneity of and the contrast between signals corresponding to tags and signals corresponding to background. Images processed using embodiments of the invention may provide more accurate spectral images for spectral analysis utilizing one or more spectral analysis methods.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described exemplary embodiments of the invention.

### BRIEF DESCRIPTION OF THE DRAWINGS

FIG. 1 is a flowchart of an automated medical image processing process consistent with the invention.

FIG. 2 is a block diagram of an exemplary apparatus suitable for implementing steps from the process of FIG. 1.

FIGS. 3A and 3B are example illustrations of a voxel neighborhood that may be analyzed by the process of FIG. 1.

FIG. 4 is a flowchart illustrating a sequence of operations that may be performed by the process of FIG. 1.

FIG. 5 is a flowchart illustrating a sequence of operations that may be performed by the process of FIG. 1.

FIG. 6 is an example chart of a first order appearance model that may be utilized by the process of FIG. 1.

FIG. 7 is a flowchart illustrating a sequence of operations that may be performed by the process of FIG. 1.

FIG. 8 is an example of CMR images in the spatial and spectral domain at various stages of the process of FIG. 1.

FIGS. 9A-C are simulated tagged CMR images that may be processed by the process of FIG. 1.

FIGS. 10A-C are illustrations of computed strain for simulated CMR images that may be generated after processing the images with the process of FIG. 1.

FIG. 10D is an example chart illustrating computed strains for the simulated CMR images of FIGS. 10A-C.

FIGS. 11A and 11B are example spectra images, where FIG. 11B is the processed version of FIG. 11A using the process of FIG. 1.

FIGS. 12A-C are example strain variance maps that may be generated after processing the simulated CMR images of FIGS. 10A-C using the process of FIG. 1.

FIGS. 13A-D are example in-vivo spatial and spectral CMR images that may be processed and/or generated by the process of FIG. 1.

FIG. 14 is chart of experimental results for an example embodiment of the process of FIG. 1.

FIGS. 15A and 15B are example in-vivo data strain maps, where FIG. 15A is a data strain map without processing, and FIG. 15B is a data strain map generated after processing corresponding CMR images using the process of FIG. 1.

### DETAILED DESCRIPTION

Embodiments consistent with the invention provide for automated processing of tagged cardiovascular magnetic resonance (CMR) images to generate improved tagged CMR images. As compared to the unprocessed CMR images, the processed CMR images may include reduced noise across one or more tag lines, augmented gradients across a tag profile (i.e., a plurality of tag lines for a set of CMR images), and amplified tag-to background contrast for the spectral domain. The CMR images may include a plurality of virtual tags inside soft tissues of the images, and tag lines may be based on magnetic spin in the tagged tissues, such that motion in the tagged tissue may be measured from tagged images. The image noise may be reduced and the tag-to-background contrast may be improved by using a three dimensional energy analysis method based on probabilistic first- and second-order prior models of the visual appearance of tagged CMR images. The method may account for multiple pairwise spatiotemporal (in-plane space and time) signal interactions, and accurate voxel-wise classification based on the marginal probability distributions of the tag and background signals. Further details regarding the techniques described herein are provided in M. Nitzken, G. Beache, A. Elnakib, F. Khalifa, G. Gimel'farb, and A. El-Baz, “Improving Full-Cardiac Cycle Strain Estimation from Tagged CMR by Accurate Modeling of 3D Image Appearance Characteristics,” IEEE Int. Symposium on Biomedical Imaging (ISBI 2012), Barcelona, Spain, May 2-5, 2012, which is incorporated by reference in its entirety.

Some embodiments of the invention, for example, may perform post-processing of tagged CMR images in the spatial domain to reduce noise across the tag lines, which unsharpens the tag edges, and to amplify the tag-to-background contrast, leading to a representation that affords more efficient computations in the spectral domain. A 3D energy minimization framework may be used for each tagged CMR image, based on learning first- and second- order visual appearance models. The first-order appearance modeling may use adaptive Linear Combinations of Discrete Gaussians (LCDG) to optimally approximate the empirical marginal probability distribution of image signals, for both the tag and background submodels, and to classify the tag lines and background. The second-order modeling may consider the image as a translation- and rotation- invariant 3D Markov-Gibbs Random Field (MGRF) with multiple pairwise voxel interactions. A 3D energy function for this model may be derived by using the analytical estimation of the spatiotemporal geometry, and Gibbs potentials of interaction. To improve computations, via augmenting both the tag and the background homogeneity and contrast, the given image may be adjusted using comparisons to the minimization function.

In some embodiments of the invention, parameters associated with the tagged CMR images may be estimated based on appearance of the parameters, including estimating the parameters based on gray level intensities. Embodiments of the invention may estimate tag lines in a CMR image by generating a three dimensional (3D) model of the CMR images. The CMR images may be two dimensional (2D) comprising two spatial dimensions (e.g., ‘x’ and ‘y’), and the 3D model may map the 2D CMR images on a temporal dimension or a time axis (e.g., ‘t’), such that the 3D model comprises spatiotemporal three dimensional voxels with (x, y, t) coordinates. Signals included in the CMR images may correspond to tags or background, where the signals may be represented in the 2D images and the 3D model by gray level intensities.

In some embodiments of the invention, the tagged CMR images may be processed by determining a linear combination of discrete Gaussians (LCDG) that estimate the signals of the 3D model. The discrete Gaussians may be separated into two submodels: a submodel corresponding to the signals corresponding to the tags and a submodel corresponding to the signals corresponding to the background. Further details regarding the use of Expectation-Maximization (EM) techniques to separate LCDGs into submodels are provided in A. El-Baz and G. Gimel'farb, “EM based approximation of empirical distributions with linear combinations of discrete Gaussians,” in Proc. IEEE Int. Conf. on Image Processing (ICIP 2007), vol. 4, Oct. 16-19 2007, pp. 373-376.

In some embodiments of the invention, the tagged CMR images may be processed by modeling the signals of the tagged CMR images with a second-order probabilistic model of characteristic voxel-wise and pairwise voxel signal dependencies with a generic translation and rotation invariant central symmetric Markov-Gibbs random field (MGRF) model. Pairwise voxel potentials of the MGRF model may be based at least in part on signal differences. Such signal differences may be determined based on gray level intensities for voxels and the difference in intensity levels between one or more neighboring voxels. A Gibbs energy function of estimated signals of the CMR images may be generated based at least in part on the voxel potentials and pairwise voxel potential differences of the MGRF model.

Each estimated signal from the MGRF may be classified as a tag line or background signal based at least in part on the submodels of the LCDG model. Voxels and the corresponding pixels of the 2D CMR images may be adjusted by a small bias based on a threshold determined from the LCDG submodels to thereby generate processed tagged CMR images.

For example, in one illustrative embodiment, a set of images, DICOM or other format, is read into memory. The images are then stacked on top of one another to create a cube of the images, where the X- and Y-axes represent the images and the Z-axis represents time. Next, first-order modeling is used to approximate the empirical marginal probability distribution of the CMR signals within a cardiac cycle data set. To do this, an adaptive linear combination of discrete Gaussians (LCDG), with positive and negative components, may be used to separate and individually classify the tag lines and the background.

Once the classifier curves are constructed in this illustrative embodiment, a weighted sphere is constructed such that certain values within the sphere are given priority over others. Next, second-order modeling considers the images as samples of a translation/rotation-invariant 3D Markov-Gibbs random field (MGRF) of voxel signals with multiple pairwise spatiotemporal (in-plane space and time) interactions. The weighted sphere begins in the first image such that its center plane is positioned on the first image and it stretches horizontally in the current image as well as stretches into the future and past images (those below and above it, respectively). The points within the sphere are then extracted for analysis. The value of each extracted point in the sphere is adjusted by the weight of that location in the sphere, such that past information is more important than future information. Using an equation based on the MGRF model the minimum energy pixel may be found within the weighted sphere. If this pixel belongs to a tag line, by comparing it with the LCDG model, then the value is reduced by a delta. If it belongs to the non-tag class then the value is incremented by a delta.

The entire matrix of image information may then be processed image by image and in a fashion such that the algorithm progresses linearly from the image most in the past to the image most in the future. The results may be stored to a second matrix. After completion, the matrix may then be sub-divided back into the original images, which may be written to a separate “processed” folder using the format that the original images were recorded in, e.g., DICOM, with the finalized images possessing an improved spectral representation to the original images, and with the noise in the spectral domain significantly reduced.

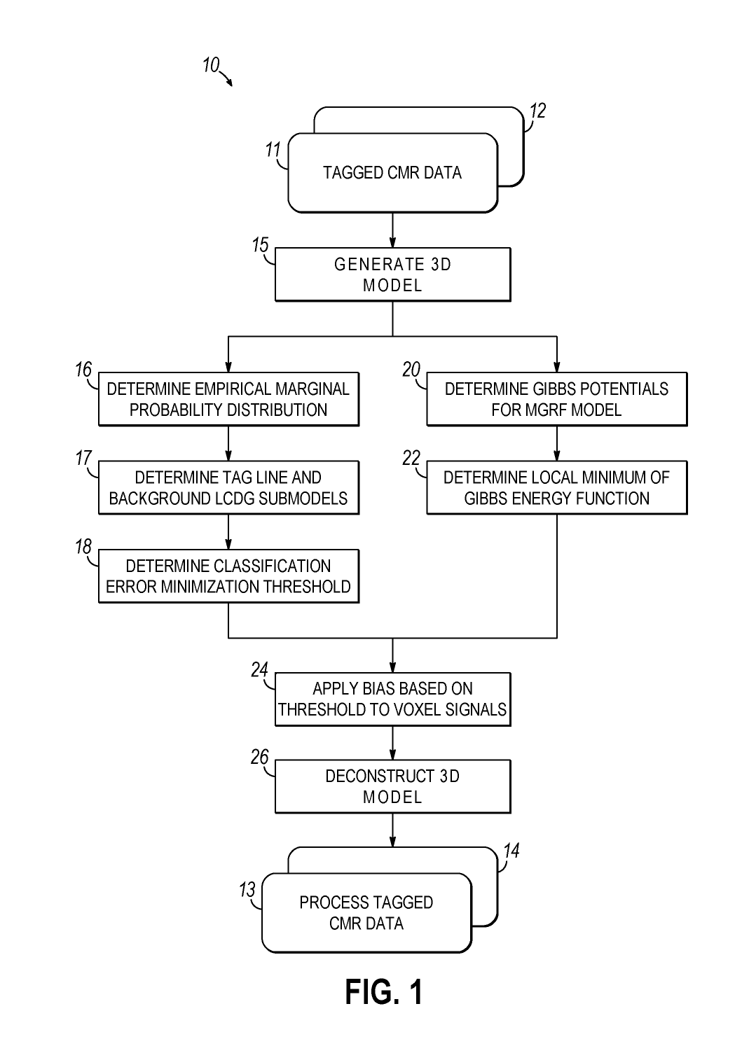

Now turning to the Drawings, wherein like numbers denote like parts throughout the several views, FIG. 1 illustrates an exemplary automated process 10 for processing tagged CMR images 11,12 consistent with embodiments of the invention to generate processed tagged CMR images 13, 14 including reduced noise across one or more tag lines, augmented gradients across a tag profile, and amplified tag-to background contrast for the spectral domain as compared to the unprocessed CMR images 11, 12. Process 10 receives as input one or more tagged CMR images 11, 12, and begins by generating a three dimensional model (3D) model based on the tagged CMR images (block 15). Each tagged CMR image generally comprises a two dimensional (2D) image at a particular time of a cardiac cycle. The CMR image includes a 2D space including signals (i.e., gray level intensities) for each 2D point (i.e., a “pixel”) of the image. Embodiments of the invention may generate a 3D model comprising two spatial coordinates (e.g., ‘x’ and ‘y’) and a time coordinate (e.g., ‘t’), where each 3D point (i.e., a “voxel”) may be based on a corresponding pixel of a 2D point of a CMR image and a time associated with the CMR image and may include a signal (i.e., a gray level intensity) based on such corresponding pixel. The process analyzes the 3D model to determine an empirical marginal probability distribution for signals of the CMR images using a LCDG model (block 16). The process 10 determines a tag line submodel for voxel signal groups corresponding to tag lines of the CMR images and a background submodel for voxel signal groups corresponding to background of the CMR images from the LCDG model (block 17). A signal threshold is determined which minimizes an error associated with the classification of voxel signal groups into the tag submodel or the background submodel (block 18).

The process 10 determines Gibbs potentials of voxels of the 3D model utilizing a MGRF model (block 20), and the process determines a local minimum Gibbs energy function for the MGRF model (block 22). Based on the threshold determined in block 18, each estimated signal value of the Gibbs energy function is classified as corresponding to a tag line or background, and a bias is applied to the estimated signal value of each voxel based on the classification of the estimated signal value (block 24), and the 3D model is deconstructed into the corresponding 2D CMR images (26), The signals of each pixel of the 2D CMR images have been adjusted based on the bias applied to the corresponding voxel to thereby generate processed tagged CMR images 13, 14.

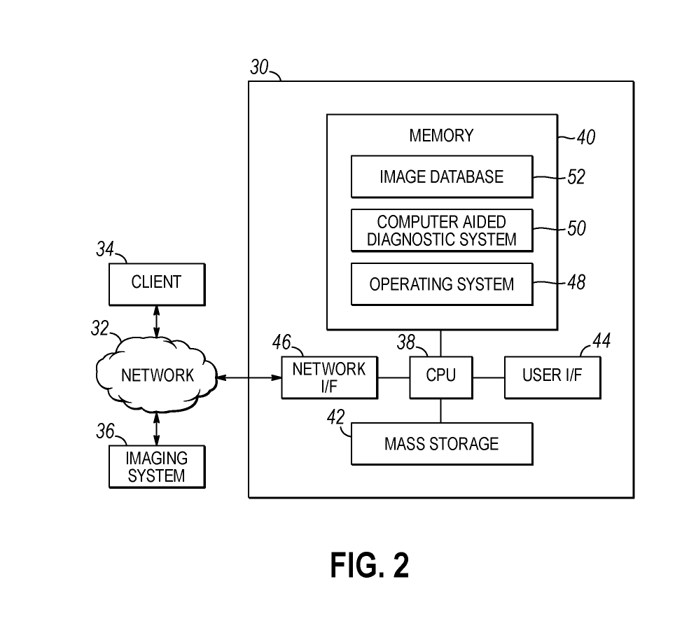

One or more steps in process 10 may be implemented in an automated fashion, utilizing a computer or other electronic device to implement such steps. FIG. 2, for example, illustrates an exemplary apparatus 30 within which various steps from process 10 may be implemented in a manner consistent with the invention. Apparatus 30 in the illustrated embodiment is implemented as a server or multi-user computer that is coupled via a network 32 to one or more client computers 34, as well as an imaging system 36, e.g., a cardiac magnetic resonance scanner. For the purposes of the invention, each computer 30, 34 may represent practically any type of computer, computer system or other programmable electronic device. Moreover, each computer 30, 34 may be implemented using one or more networked computers, e.g., in a cluster or other distributed computing system. In the alternative, computer 30 may be implemented within a single computer or other programmable electronic device, e.g., a desktop computer, a laptop computer, a handheld computer, a cell phone, a set top box, etc.

Computer 30 typically includes a central processing unit 38 including at least one microprocessor coupled to a memory 40, which may represent the random access memory (RAM) devices comprising the main storage of computer 30, as well as any supplemental levels of memory, e.g., cache memories, non-volatile or backup memories (e.g., programmable or flash memories), read-only memories, etc. In addition, memory 40 may be considered to include memory storage physically located elsewhere in computer 30, e.g., any cache memory in a processor in CPU 38, as well as any storage capacity used as a virtual memory, e.g., as stored on a mass storage device 42 or on another computer coupled to computer 30. Computer 30 also typically receives a number of inputs and outputs for communicating information externally. For interface with a user or operator, computer 30 typically includes a user interface 44 incorporating one or more user input devices (e.g., a keyboard, a mouse, a trackball, a joystick, a touchpad, and/or a microphone, among others) and a display (e.g., a CRT monitor, an LCD display panel, and/or a speaker, among others). Otherwise, user input may be received via another computer or terminal.

For additional storage, computer 30 may also include one or more mass storage devices 42, e.g., a floppy or other removable disk drive, a hard disk drive, a direct access storage device (DASD), an optical drive (e.g., a CD drive, a DVD drive, etc.), and/or a tape drive, among others. Furthermore, computer 30 may include an interface 46 with one or more networks 32 (e.g., a LAN, a WAN, a wireless network, and/or the Internet, among others) to permit the communication of information with other computers and electronic devices. It should be appreciated that computer 30 typically includes suitable analog and/or digital interfaces between CPU 36 and each of components 40, 42, 44 and 46 as is well known in the art. Other hardware environments are contemplated within the context of the invention.

Computer 30 operates under the control of an operating system 48 and executes or otherwise relies upon various computer software applications, components, programs, objects, modules, data structures, etc., as will be described in greater detail below. Moreover, various applications, components, programs, objects, modules, etc. may also execute on one or more processors in another computer coupled to computer 30 via network 32, e.g., in a distributed or client-server computing environment, whereby the processing required to implement the functions of a computer program may be allocated to multiple computers over a network.

As an example, computer 30 may include a computer aided diagnostic (CAD) system program 50 used to implement one or more of the steps described above in connection with process 10. For the purposes of implementing such steps, an image database 52, storing CMR scan images, may be implemented in computer 30. It will be appreciated, however, that some steps in process 10 may be performed manually and with or without the use of computer 30.

In general, the routines executed to implement the embodiments of the invention, whether implemented as part of an operating system or a specific application, component, program, object, module or sequence of instructions, or even a subset thereof, will be referred to herein as “computer program code,” or simply “program code.” Program code typically comprises one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of computer readable media used to actually carry out the distribution. Examples of computer readable storage media include but are not limited to physical, tangible storage media such as volatile and non-volatile memory devices, floppy and other removable disks, hard disk drives, magnetic tape, optical disks (e.g., CD-ROMs, DVDs, etc.), among others.

In addition, various program code described herein may be identified based upon the application within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the invention is not limited to the specific organization and allocation of program functionality described herein.

### Spatiotemporal Model

Embodiments of the invention may generate a spatiotemporal model consistent with embodiments of the invention. Based on the 2D CMR images, embodiments of the invention may generate a 3D model having a coordinate set r=(x, y, t) and a lattice R=[(x,y,t):x=0, . . . , X−1; y=0, . . . , Y−1; t=0, . . . , T−1] may denote a voxel with two spatial (x, y) and one time (t) coordinates of a spatiotemporal lattice of the size R=XYT. A finite set of signals for the 2D CMR images (i.e., gray level values) may be defined as Q={0, . . . , Q−1}. The lattice, R, supports 3D CMR images g=[g(r):r ∈ R; g(r) ∈ Q] comprising the 2D CMR images taken in successive time instants (“time slices”). The 3D model of the CMR images may be analyzed by describing the visual appearance of the images with a first-order model of marginal probability distributions of tag and background signals and a second-order probabilistic model of characteristic voxel-wise and pairwise voxel signal dependencies.

### Second Order Appearance Model

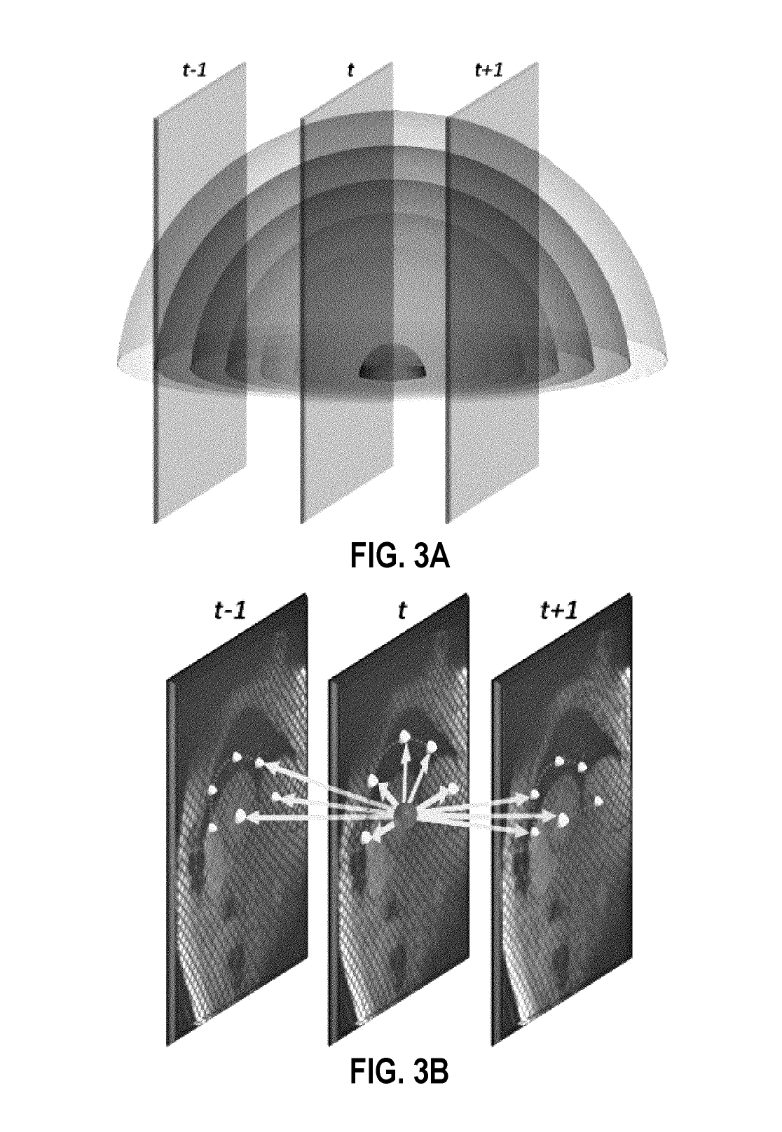

A translation- and rotation-invariant generic second-order MGRF of images g is specified by a certain number, N, of characteristic central-symmetric voxel neighborhoods nᵥ; v=1, . . . , N on R. FIG. 3A provides an example illustration of a central-symmetric second order 3D neighborhood system for an MGRF model, with respect to time coordinates for a particular spatiotemporal voxel represented by the central dot. FIG. 3B provides an example illustration of a 3D rotation-invariant neighborhood of a voxel on CMR images aligned in a 3D model. Referring to FIGS. 3A and 3B, for a given temporal snapshot, t, each voxel interacts with its nearest neighbors, and both the preceding, from t−1, and subsequent, from t+1, voxel interactions are used to optimize the voxel values at time t. Only upper halves of the spherical neighborhoods are depicted for clarity.

Each voxel neighborhood nᵥ may indicate a family of voxel pairs, Cᵥ={c_{ν}=(r, r′): r′−r ∈ n_{ν}; r,r′∈ R}, such that their intervoxel distances (norms of the coordinate offsets o=r′−r) belong to an indexed semi-open interval [d_{v:min}, d_{v:max}):

d_{ν:min}≦\sqrt{(x−x′)²+(y−y′)²+(t−t′)²} <d_{ν:max} (1)

with fixed thresholds d_{v:min} and d_{v:max}. Such neighboring pairs may be considered second-order cliques of the neighborhood graph with nodes in the voxels.

Cliques from the family Cᵥ support the same real-valued Gibbs potential Vᵥ(g(r), g(r′)) of pairwise voxel interaction. In some embodiments, uniform brightness changes may be uniformly accounted for by determining a Gibbs potential based at least in part on the absolute intra-clique signal difference: Δ=|g(r)−g(r′|∈ D={0, 1, . . . , Q−1}. The potential values may be represented as one or more column vectors V_{ν}=[V_{ν}(Δ): Δ∈ D]. Characteristic cliques may be stratified into N families, {Cᵥ: v=1, . . . , N} and the potentials Vᵥ and embedded non-intersecting distance intervals : d_{1:min}<d_{1:max}≦d_{2:min}< . . . ≦d_{N:min}<d_{N:max}.

As discussed in G. Gimel'farb, Image Textures and Gibbs Random Fields, Kluwer Academic, 1999, an MGRF consistent with some embodiments of the invention may include a Gibbs probability distribution:

$$\begin{matrix}P ( g ) = \frac{1}{{Z}_{v}} exp ( \vert R \vert {V}^{T} F ( g ) ) \\ ≡ \frac{1}{{Z}_{v}} exp ( \vert R \vert ( {V}_{vox}^{T} {F}_{vox} ( g ) + {\sum }_{v = 1}^{N} {ρ}_{v} {V}_{v}^{T} {F}_{v} ( g ) ) )\end{matrix} \qquad ( 2 )$$

where T indicates the transposition, Zᵥ is the normalizing factor (the partition function) depending on the first and second order potentials V=[Vᵥₒₓ; Vᵥv=1, . . . , N] for the neighborhoods {nᵥ: v=1, . . . , N},

$${ρ}_{v} = \frac{\vert {C}_{v} \vert}{\vert R \vert}$$

and is the relative size of the clique family with respect to the lattice cardinality |R|=XYT, i.e., the relative number of cliques in the family Cᵥ. A column vector F(g)=[Fᵥₒₓ(g); ρ_{ν}F_{ν}(g): ν=1, . . . N] includes relative empirical frequencies ƒᵥₒₓ(q|g) of signals q ∈ Q in the voxels and frequencies ƒ_{ν}(Δ|g) of absolute signal differences Δ∈ D in the cliques from the family Cᵥ for the image g, respectively:

$${F}_{vox} ( g ) = [ {f}_{vox} ( q \vert g ) = \frac{\vert {R}_{q} ( g ) \vert}{\vert R \vert} ; q ∈ Q ] ;$$

$${\sum }_{q ∈ Q} {f}_{vox} ( q \vert g ) = 1$$

$${F}_{v} ( g ) = [ {f}_{v} ( Δ \vert g ) = \frac{\vert {C}_{v : Δ} ( g ) \vert}{\vert {C}_{v} \vert} ; Δ ∈ D ] ;$$

$${\sum }_{Δ ∈ D} {f}_{v} ( Δ \vert g ) = 1$$

where the sublattice R_{q}(g) includes all the voxels r, such that g(r)=q, and the subfamily C_{ν:Δ(g)} includes all the pairwise cliques cᵥ=(r, r′) of the family such that |g(r)−r′)|=Δ. First approximations of the maximum likelihood estimates of the potentials may be considered:

Vᵥₒₓ(q)=λ(ƒ(q|g)−ƒ_{irf:vox}(q)); q ∈Q;

V_{ν(Δ)=λ(ƒ}_{ν}(Δ|g)−ƒ_{irf:dif}(Δ)); Δ∈ D; ν=1, . . . , N (3)

where the common scaling factor λ, is also computed analytically, and

$${f}_{irf \text{:} vox} ( q ) = \frac{1}{Q}$$

may denote the probability of the voxel signal q and the intervoxel signal difference Δ, respectively, for the independent random field of equiprobable signals:

$${f}_{irf \text{:} dif} ( Δ ) = \{ \begin{matrix}\frac{1}{Q} & if Δ = 0 \\ \frac{2}{{Q}^{2}} ( Q - Δ ) & otherwise\end{matrix}$$

The factor λ may be omitted (i.e., set to λ=1) if only relative interaction energies E_{rel:v} are computed for the clique families in order to select the most characteristic ones.

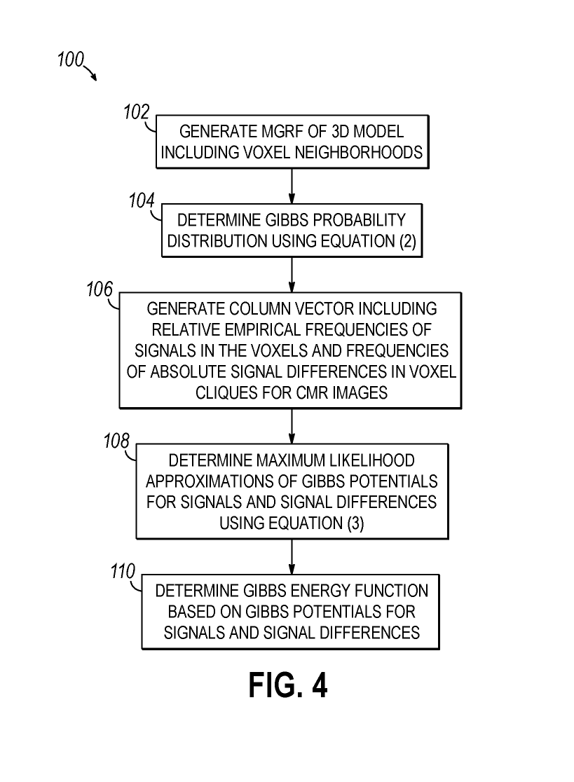

Turning now to FIG. 4, this figure provides flowchart 100, which illustrates a sequence of operations that may be performed by process 10 consistent with embodiments of the invention to determine a minimized Gibbs energy function associated with the 3D model of CMR images. A MGRF model may be generated for the 3D model of the CMR images (block 102), where such MGRF model includes voxel neighborhoods as shown, for example, in FIGS. 3A and 3B. A Gibbs probability distribution may be determined for the 3D model based at least in part on equation (2) provided above (block 104). A column vector ‘F(g)’ may be generated including relative empirical frequencies of signals in the voxels and frequencies of absolute signal differences in voxel cliques for the CMR images of the 3D model (block 108). Maximum likelihood approximations of Gibbs potentials for signals and signal differences may be determined based at least in part on equation (3) (block 108), as will be discussed in further detail below, and a Gibbs energy function based on Gibbs potentials for the estimated signals and absolute signal differences may be determined (block 110).

Analytical first approximation of the maximum likelihood estimates for equation (3) for MGRF potentials of a first and second order, V=(Vᵥₒₓ; V₁, . . . , V_{N}), in equation (2), may be based on analysis of one or more training images. The estimates may maximize in the space of potentials V the likelihood P(g°) of a given training image g°, or its specific log-likelihood:

$$L ( V \vert {g}^{o} ) = \frac{1}{R} log ( P ( {g}^{o} ) ) = {V}^{T} F ( {g}^{o} ) - \frac{1}{R} log {Z}_{v}$$

where F(g°)=└Fᵥₒₓ(g°);ρ_{ν}V_{ν}^{T}F_{ν}(g°):ν=1, . . . , N┘ is the vector is the vector of empirical marginal probabilities of voxel signals and scaled empirical marginal probabilities of inter-voxel signal differences (see Second Order Model Above). The factor Zᵥ normalizes the probability distribution over the entire set Q^{R} of the discrete spatiotemporal images sequences g:

$${Z}_{v} = {\sum }_{g ∈ g} exp ( R ( {V}^{T} F ( g ) ) ) ⇔ {\sum }_{g ∈ g} P ( g ) = 1$$

where γᵥ denote the first vectorial derivative, i.e., the gradient

$$\frac{\partial L ( V \vert {g}^{o} )}{\partial V}$$

of the log-likelihood at the point V of the potential space. As such,

$${γ}_{v} = F ( {g}^{o} ) - \frac{1}{R} \frac{\partial Z v}{\partial V} = F ( {g}^{o} ) - E \{ F ( g ) \vert V \} \qquad ( 6 )$$

as the gradient

$$\frac{\partial \vert {Z}_{v}}{\vert \partial V}$$

of the factor Zv in the potential space is proportional to the mathematical expectation E{F(g)|V}=Σ_{g∈g} F(g)P(g) of the empirical marginals F(g) for the MGRF model of image sequences g. The gradient of equation (6) is considered equal to zero for the MLE of potentials, such that the marginal probabilities of signals and their differences for the estimated MGRF are equal to the relevant training marginals. Furthermore, the function L(V|g° is concave in the potential space and has a unique maximum because its second vectorial derivative (the Hessian matrix)

$${H}_{v} = \frac{{\partial }^{2}}{\partial {V}^{2}} L ( V \vert {g}^{o} ) = - \frac{\partial }{\partial V} E \{ ( g ) \vert V \}$$

is equal to the negated covariance matrix for the marginals of the MGRF and thus is non-positive definite.

Both the factor Zv and its vectorial derivatives in the potential space are generally intractable, except of special cases when the corresponding marginals are computable, like e.g. an independent random field (IRF) with statistically independent voxel-wise components. In particular, the origin V=0 of the potential space corresponds to the IRF of equiprobable independent voxel signals. In such case, Zₒ=|g|=Q^{R}, L=(0|g°)=log Q, and the corresponding marginal probabilities of the voxel signals and inter-voxel signal differences to form the vector of the scaled expected marginals F_{irf}=[F_{irf;vox};ρ₈₄ F_{irf:dif}: ν=1, . . . , N], and the uniformly distributed signals,f_{irf:dif}(q)=1/Q, and the triangularly distributed differences,

$${f}_{irf \text{:} dif} ( Δ ) = \frac{1}{{Q}^{2}} ( Q - Δ )$$

of the independent equiprobable signals, respectively.

The analytical approximation of the MLE in Eq. (3) is obtained by maximizing the truncated Taylor's series decomposition of the log-likelihood in the vicinity of the origin V=0 along the gradient direction V=λ|γₒ=λ(F(g°)−F_{irf}):

$$\begin{matrix}\tilde{L} ( λ \vert {g}^{o} ) = log Q + {V}^{T} {γ}_{o} - \frac{1}{2} {V}^{T} {H}_{o} V \\ = log Q + λ {γ}_{o}^{T} γ - \frac{1}{2} {V}^{T} {H}_{o} V - \frac{1}{2} {λ}^{2} {γ}_{o}^{T} {H}_{o} {γ}_{o}\end{matrix}$$

The maximizer

$$λ \vert = \frac{{γ}_{O}^{T} {γ}_{o}}{{γ}_{O}^{T} {H}_{o γ o}}$$

follows from the condition

$$\frac{d}{d λ} \tilde{L} ( λ \vert {g}^{o} ) = 0.$$

As discussed in the aforementioned publication Image Textures and Gibbs Random Fields, statistical dependencies between the pairwise signal differences in image sequences are weak and thus may be ignored, this maximizer is also computed analytically by approximating the Hessian matrix with the diagonal matrix of scaled variances of the marginal probabilities.

### First Order Appearance Model

The CMR images of the 3D model may be described using a linear combination of discrete Gaussians as described in the aforementioned article “EM based approximation of empirical distributions with linear combinations of discrete Gaussians.” A discrete Gaussian (DG) Ψ_{θ}=(ψ(q|θ): q ∈ Q is defined as a discrete probability distribution with Q components obtained by integrating a continuous one dimensional (1D) Gaussian Density

$$ϕ ( q ) θ ) = \frac{1}{\sqrt{2 π σ}} exp ( - \frac{{( q - μ )}^{2}}{2 {σ}^{2}} )$$

with parameters θ=(μ, σ), where μ is the mean and σ² is the variance over Q intervals related to the successive integer signal values in Q: if Φ_{θ}(q)=∫_{-∞}^{q}φ(z|θ)dz is the cumulative Gaussian probability function, then ψ(0|θ)=Φ_{θ}(0.5), ψ(q|θ)=Φ_{θ}(q+0.5)−Φ_{θ}(q−0.5) for q=1, . . . , Q−2, and ψ(Q−1|θ)−1−Φ_{θ}(Q−1.5)

The tag-to-background contrast may be improved by approximating the empirical marginal 1D signal distribution for the CMR images of the 3D model with a linear combination of discrete Gaussians (LCDG) P_{w,Θ}=[p_{w}, Θ(q):q ∈ Q]; Σ_{q∈ Q}p_{w}, Θ(q)=1, including two positive dominant and multiple sign-alternate subordinate DGs:

$${P}_{w , Θ} ( q ) = {\sum }_{k = 1}^{{K}_{p}} {w}_{p : k} ψ ( q \vert {θ}_{p : k} ) - {\sum }_{l = 1}^{{K}_{n}} {w}_{n : l} ψ ( q \vert {θ}_{n : l} ) \qquad ( 4 )$$

Kₚ; Kₚ≧2, and Kₙ; Kₙ≧0, may be total numbers of the positive and negative DGs, and w=[w_{p:k}, w_{n:l}] may be non-negative weights that meet the constraint Σₖ₌₁^{K}^{ₚ}w_{p:k}−Σₗ₌₁^{K}^{ₙ}w_{n:l}=1. Subordinate DGs may approximate the deviations of the empirical distribution from the conventional mixture of dominant positive DGs.

The first order LCDG model may be built and separated into the two LCDG submodels of the tag lines and their background. The building and separating the LCDG model into LCDG submodels may be performed using the Expectation- Maximization techniques provided in the aforementioned article, “EM based approximation of empirical distributions with linear combinations of discrete Gaussians.” The number of dominant DGs (K=2), the numbers Kₚ−K and Kₙ of the positive and negative subordinate DGs, as well as the weights and parameters (the means and variances) of all the DGs are initialized first with a sequential EM-based algorithm in order to produce a close initial LCDG approximation of the empirical distribution. Based on the fixed numbers of the components, Kp and Kn, all the weights and parameters are refined with a conventional EM algorithm, where the conventional EM algorithm may account for the sign-alternate components. The refined LCDG model may partitioned into the two LCDG submodels. The refined LCDG model may be separated into the two LCDG submodels P_{vox:a}|=[P_{vox:a}(q):q ∈ Q], one per class α ∈ {tag, background}, by associating the subordinate DGs with the dominant ones in such a way as to minimize the tag/background misclassification rate.

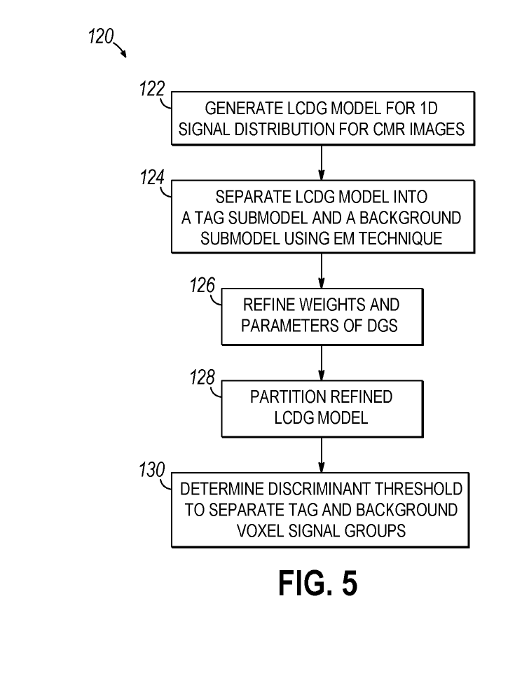

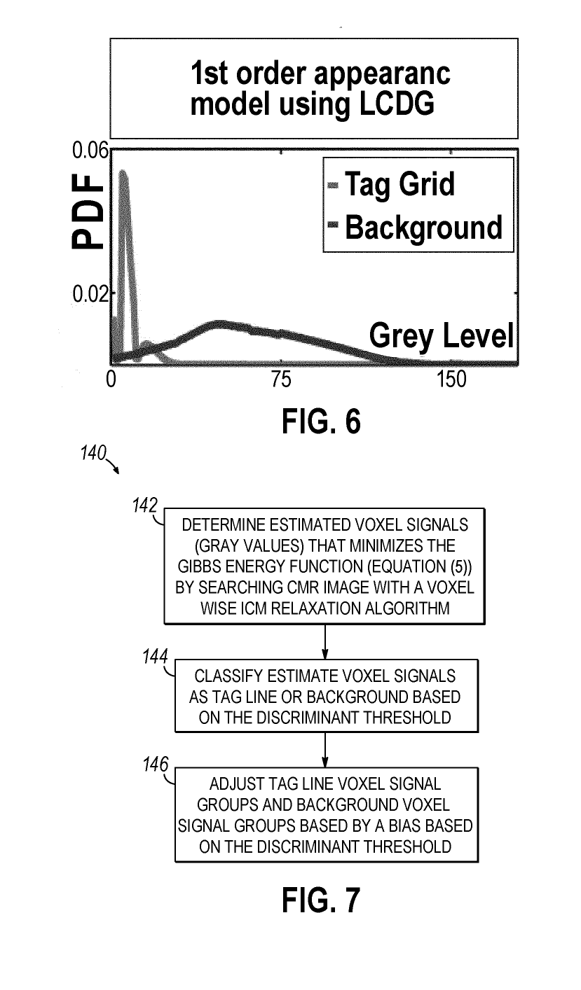

Turning to FIG. 5, this figure provides flowchart 120, which illustrates a sequence of operations that may be performed by process 10 consistent with embodiments of the invention to analyze the CMR images using a LCDG model. A LCDG model is generated for the 3D model of CMR images including a 1D signal distribution (block 122). FIG. 6 illustrates an example 1^{st} order appearance model using LCDGs, illustrating the probability of distribution of each type of signal (i.e., tag line or background) based on the gray level intensity value. The LCDG model is separated into a tag submodel and a background submodel using an EM technique as described above (block 124). The weights and parameters (i.e., the means and variances) of all DGs in the LCDG are initialized with a sequential EM based algorithm and refined with another EM algorithm modified to account for the sign-alternate components (block 126). The refined LCDG model is partitioned into a tag submodel and a background submodel (block 128), and a discriminant threshold is determined that minimizes the classification error of voxel signal groups to the tag submodel or the background submodel.

### Energy Minimization to Improve Tagged CMR Images

The tagged CMR images g of the 3D model may be adjusted by utilizing a voxel-wise Iterative Conditional Mode (ICM) relaxation algorithm to search for a local minimum of the Gibbs energy function for the second order MGRF appearance model:

$$\hat{g} = arg {min}_{g ∈ {Q}^{XYT}} \{ {V}_{vox}^{T} F ( g ) + {\sum }_{v = 1}^{N} {ρ}_{v} {V}_{v}^{T} {F}_{v} ( g ) \} \qquad ( 5 )$$

where the probability vectors Fᵥₒₓ(g) and Fᵥ(g) are collected over the generated tagged CMR images. To improve the tag-background contrast, each estimated signal value, ĝ(r); r ∈ R, is classified as belonging to either the tag line or the background by using the first-order LCDG modeling. The voxels are nudged towards their proper grouping by incrementing or decrementing their signals by a small value δ in accord with the discriminant threshold.

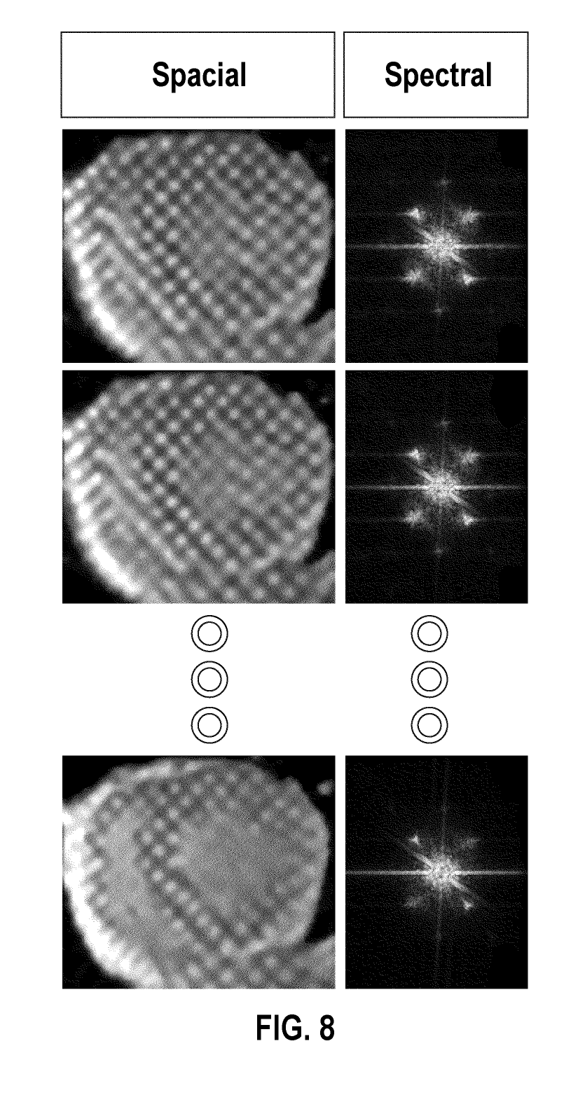

FIG. 7 provides flowchart 140, which illustrates a sequence of operations that may be performed by the process 10 to adjust CMR images consistent with embodiments of the invention. Voxel signals (i.e., gray values) are estimated for the 3D model that minimize the Gibbs energy function shown in equation (5) by searching the CMR images with a voxel wise Iterative Conditional model relaxation algorithm (block 142). Each estimated voxel signal group is classified as a tag line or background based on the determined discriminant threshold (block 144), and the voxel signals of the classified signal groups are adjusted by a bias based on the classification by a small bias determined from the discriminant threshold (block 146). FIG. 8 provides an example set of images in the spatial and spectral domain illustrating the processing of CMR images using embodiments of the invention.

### Working Examples

Three metrics: (i) the reduction in the power scatter, defined as the ratio of the power of the spectral main lobe to the power of the spectral side lobes, (ii) the ability to restore noise corrupted strain slopes for synthetic phantoms, and (iii) the homogeneity of the strains in the image as indexed using the variance, were used to analyze and validate the effectiveness of the process 10 by testing on both synthetic phantoms and in-vivo data sets, analyzing the strain with the HARP technique, and quantifying the performance.

### Validation Metrics

Relative power scatter between the main and side spectral lobes: for accurate and efficient spectral domain computations, the HARP technique requires that the information resides predominately within the central peak and the first (main) side lobe as described in N. F. Osman and J. L. Prince, “Visualizing myocardial function using HARP MRI,” Physics in Medicine and Biology, vol. 45, pp. 1665-1682, June 2000. When an image is noisy and has sharp edges in the spatial domain, a significant part of the total information resides in the outer side lobes in the spectral domain, so that HARP encounters difficulties in tracking phases of points. Therefore, minimizing the amount of information in the outer side lobes is important. Further details regarding the minimization of the amount of information in the outer side lobes are described in K. Hansen, F. Gran et al., “In-vivo validation of fast spectral velocity estimation techniques,” Ultrasonics, vol. 50, no. 1, pp. 52-59,2010 and T. Jiang and Y. Wu, “An overview: Peak-to-average power ratio reduction techniques for OFDM signals,” IEEE Transactions on Broadcasting, vol. 54, no. 2, pp. 257-268, June 2008.

Strain slope recovery: In cardiac strain analysis, the slope during the contraction phase of the cardiac cycle is a very important indicator of strain function, i.e. a cardiac systolic performance index, namely, the rate of peak contraction. Therefore, the accuracy of the slope recovery is a useful indicator to measure the effect of noise on the calculated strain for a tagged MR restoration algorithm. Additionally, the ability to derive accurate strain slope analysis indicates the HARP reliability in tracking tag intersection points through the cardiac cycle. Let S_{obs} denote the slope of the observed data set to be analyzed (e.g. of the noisy or processed observations) and let Sᵢₙᵢ be the ground truth slope, being known for the initial data set (phantom). The relative strain error is defined as

$$100 \vert 1 - \frac{{S}_{obs}}{{S}_{int}} \vert ,$$

i.e. the absolute value of the relative slope change in the noisy data with respect to the ground truth was calculated for the synthetic phantom images by using the HARP technique for the Euler strain measurements.

Variance-indexed strain homogeneity: Restoring local strain homogeneity in tagged MR images is an additional important ability of the proposed approach. This ability follows directly from the reduced spectral noise and yields more accurate estimates of quantitative strain parameters for spectral-domain techniques. Bio- mechanical models of the heart tissue as a continuous medium suggest that neighboring voxels in the heart should have similar strains, so that strain does not randomly occur in an individual voxel as discussed in K. B. Chandran, H. S. Udaykumar et al., Image-Based Computational Modeling of the Human Circulatory and Pulmonary Systems: Methods and Applications. Springer, 2010. Thus, the variance in, or homogeneity, of strain in a realistic tagged MR image should be low. This should hold true in any small region, even in the presence of injury, where transition zones may occur. Therefore, to analyze the strain homogeneity in the images before and after processing using the disclosed method, the variance index for each pixel of color strain maps was extracted using the HARP processing software and is calculated as follows. The color strain map is scaled to obtain the corresponding numerical strain map over the entire image, and the variance for each strain location over the entire image is calculated within a moving 7×7 window. The stored matrix of these variances is referred to as the variance map that allows for determining the effect of noise on the strain parametric image, or a type of roughness index. The lower the strain variance, the more accurate the strain analysis. Conversely, the high strain variance indicates that the image is noisy, and that HARP would have difficulty in tracking points from one temporal frame to another throughout the cardiac cycle.

### Validation on Synthetic Phantoms

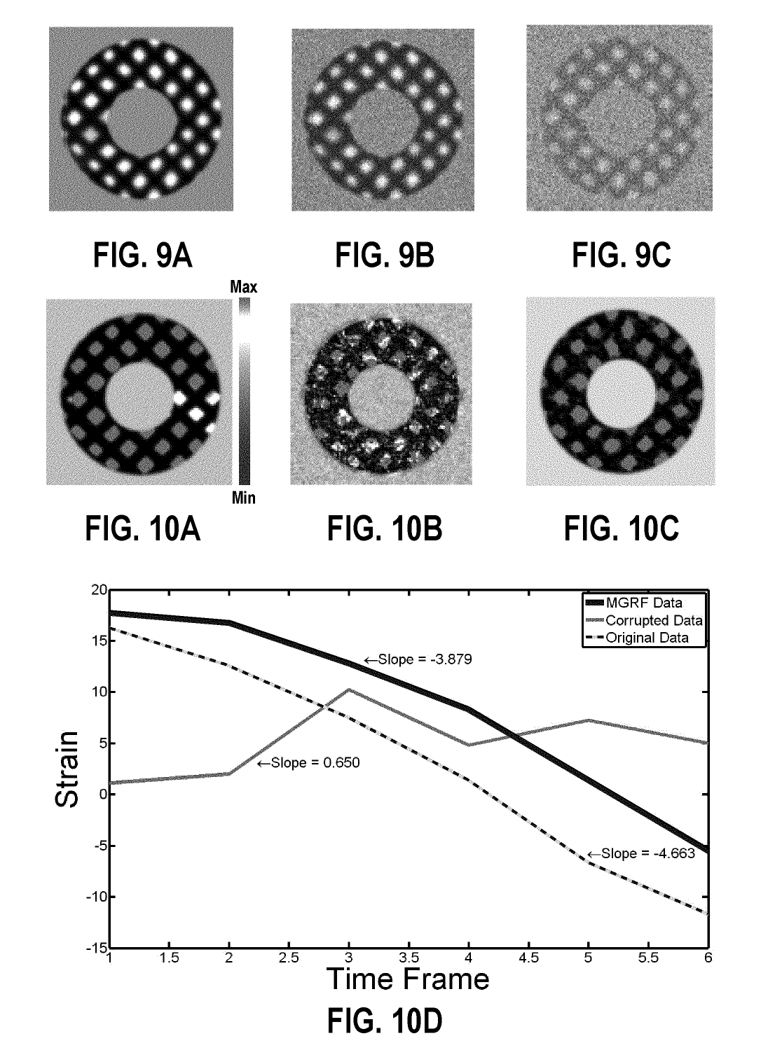

Phantoms were synthesized using a descriptive mathematical model that accounts for physical features of the left ventricle (LV) and physiological LV responses as the heart progresses through the cardiac cycle. The model uses a geometric transformation that covers the LV shearing, rotation, translation, torsion, and compression to describe the LV motion by mapping each location (i.e. a material point) defined in the model to a corresponding spatial point at a certain time instant during the cardiac cycle. Using this transformation, an inverse motion map is calculated analytically and is used to establish correspondences between two points at any two time instants. This allows for simulating tagged MR images as discussed in T. Arts, W. C. Hunter et al., “Description of the deformation of the left ventricle by a kinematic model,” Journal of Biomechanics, vol. 25, pp. 1119-1127, October 1992 and E. Waks, J. Prince et al., “Cardiac motion simulator for tagged MRI,” in Proc. Workshop on Mathematical Methods in Biomedical Image Analysis, June 1996, pp. 182-191. To derive the phantoms, a motion transformation is applied to a generated 3D LV model. Then, an image is generated by selecting an image plane that intersects the LV, and assigning every point on the image plane a value that depends on whether the point lies inside or outside the LV wall. FIG. 9A exemplifies the phantom constructed using this model.

FIGS. 9A-C provide example simulated slices (i.e., CMR images). FIG. 9A provides an original tagged MR phantom (the squares depict tag intersection grids); FIG. 9B provides a corrupted version of the CMR image of FIG. 9A with a SNR of 3.18 dB; and FIG. 9C provides a corrupted version of the CMR image of FIG. 9A with a SNR of 2.58 dB.

FIGS. 10A-C provide strain in simulated slices. FIG. 10A provides the computed strain for tagged intersection points as a parametric overlay for an original slice; FIG. 10B provides the computed strain for tagged intersection points for a noisy image; and FIG. 100 provides the computed strain for tagged intersection points for the noisy image of FIG. 10B after processing the image using embodiments of the invention. As shown, the color uniformity in FIGS. 10A and C illustrate the ability of embodiments of the invention to improve corrupted images (e.g., FIG. 10B). The color variation shown in FIG. 10B illustrates corruption caused variations in the strain grids in the spatial domain which results in sharp peaks in the spectral domain which may hinder tracking specific points with the HARP. FIG. 10D provides a chart illustrating the original strain data, corrupted data, and data processed using embodiments of the invention, illustrating that the strain slope of the corrupted data may be largely recovered as compared to the original after processing.

The known ground truth (i.e., the strain slope) for these phantoms facilitates determining that the proposed processing of noisy images may reduce the absolute strain error from approximately 94% to 36% in this simulated example. FIG. 10D, which compares the actual strain slopes calculated for the original, corrupted, and processed phantom images, demonstrates that, as expected, the strain values are decreasing linearly with time during the contraction phase of the cardiac cycle. Close similarity between the slope profiles for the improved and ground truth images demonstrates that the proposed approach accurately recovers the strain slopes for the tagged MR data.

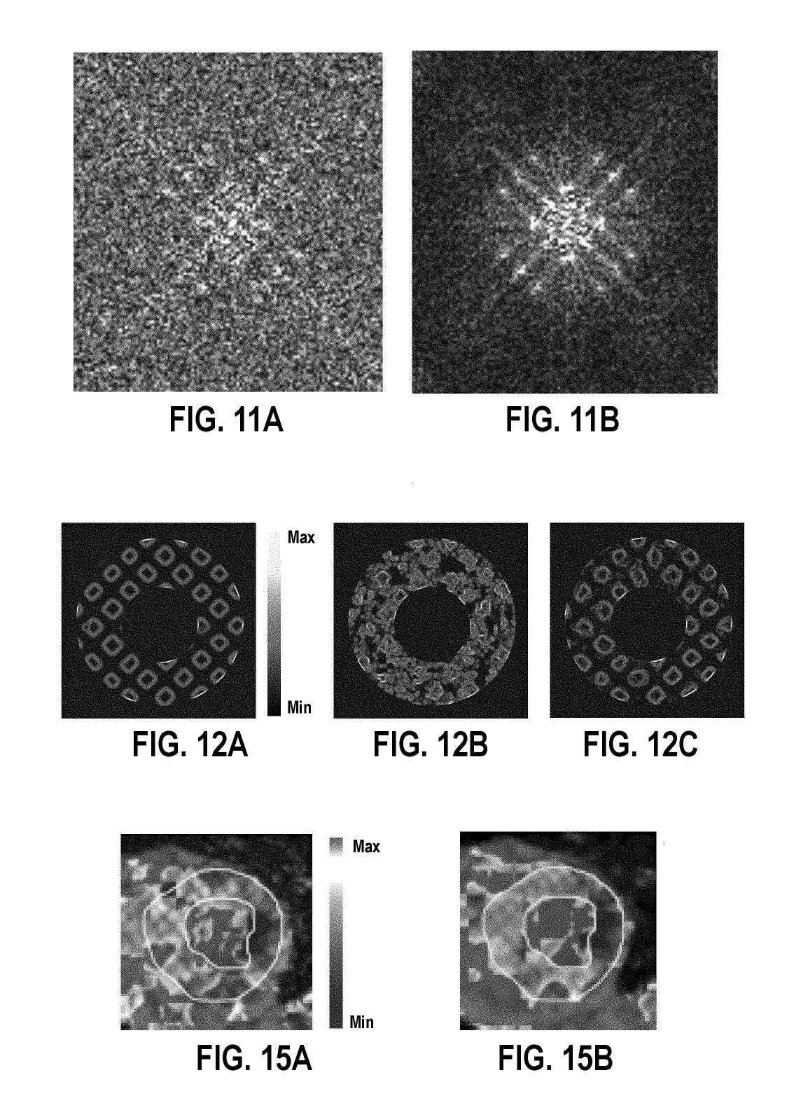

FIGS. 11A and 11B provide example Fourier spectra images. FIG. 11A provides a noisy spectra image, and FIG. 11B provides the spectra image of FIG. 11A after processing the spectra image using embodiments of the invention. In general, discrete spectral peaks can be discerned for a clean image with the majority of information residing within the main lobe and first side lobes. However, the image noise degrades the ability to observe spectral peaks in the spectrum of FIG. 11A. Embodiments of the invention may recover the spectral pattern in the spectrum FIG. 11B, particularly, the power concentrated in the central peaks. The spectral noise in the processed phantom of FIG. 11B is significantly reduced with respect to the amount of spectral noise found in the corrupted phantom of FIG. 11A.

The Fourier spectral profile of the corrupted and improved phantom images in FIGS. 11A and 11B illustrate the basis of the high accuracy of recovering the strain slope with the proposed approach. As shown in FIG. 11A, it is the spectral power scatter in the outer side lobes of the noisy phantom image that degrade the accuracy of the HARP analysis. Processing in the manner disclosed herein reduces the scatter (i.e. the amount of information distributed to the outer side lobes) and emphasizes the main lobe and the first side lobes in the spectral domain, which makes the HARP analysis much more accurate and efficient. In total, for the example experiment, processing may provide 265±20% of improvement of the spectral power ratio for the main lobe relative to the side lobes in the phantom image data set. Table I summarizes these results for the phantom data.

TABLE I

| | Before Processing | After Processing |
|---|---|---|
| Mean power scatter | 0.17 | 0.58 |
| Standard deviation | 0.012 | 0.019 |

| | |
|---|---|
| % of improvement | 265% |

In addition, the homogeneity of strain was analyzed for the phantom data set. The resulting strain homogeneity is shown in Table II for the corrupted and processed data. The improvement is statistically significant according to the unpaired t-test.

TABLE II

| | Before Processing | After Processing |
|---|---|---|
| Mean Strain Variance | 0.024 | .0092 |
| Standard deviation | 2.9E−4 | 1.8E−5 |

| | |
|---|---|
| P-value | <1E−4 |

The experiment data indicates that embodiments of the invention improve both the strain slope and strain homogeneity, as well as largely recover the strain variance profile of the original image. Pixel-wise parametric (color-coded) maps of the variances, shown in FIGS. 12A-C for the original, corrupted, and processed phantom, also demonstrate clearly the strain homogeneity and its improvement (here, the brighter the hue of an area, the larger the local strain variance).

FIGS. 12A-C provide example color coded strain variance maps. FIG. 12A provides a color coded strain variance map for an original simulated CMR image; FIG. 12B provides a color coded strain variance map noisy simulated CMR image; and FIG. 12C provides a color coded strain variance map for the simulated CMR image of FIG. 11B after processing the CMR image according to embodiments of the invention.

### Results for In-Vivo Data

Performance in real data for some embodiments of the invention were determined by processing 20 independent in-vivo data sets. Results before and after enhancing a representative example of the test images (FIGS. 13A-D) are similar to those for the phantom data. The image spectral representation shows a considerable reduction in the noise in the outer side lobes; see FIGS. 13A and 13C.

FIGS. 13A and 13B provide spatial domains for in-vivo CMR images for an original (FIG. 13A) and a processed CMR image (FIG. 13B). FIG. 13C provides an original spectral image, and FIG. 13D provides a processed spectral image. FIG. 14 provides an example data chart illustrating data sets of the percentages of the spectral improvement over a cardiac cycle for 12 time frames.

Table III below shows that embodiments of the invention may significantly reduce spectral noise in a variety of images. In these experiments the average noise reduction of 46±6% was observed in the spectral side lobes for the 20 independent in- vivo data sets. Additionally, FIG. 14 plots for all the data sets the percentages of the spectral improvement over the entire cardiac cycle for each frame out of the 12 time frames. The mean improvement of embodiments of the invention generally provides largely constant improvements over the entire cardiac cycle and illustrates that embodiments may improve the power distributions in both the systolic and diastolic phases.

TABLE III

| | Before Processing | After Processing |
|---|---|---|
| Mean power scatter | 1.40 | 2.0 |
| Standard deviation | 0.19 | 0.31 |

| | |
|---|---|
| % of improvement | 46% |

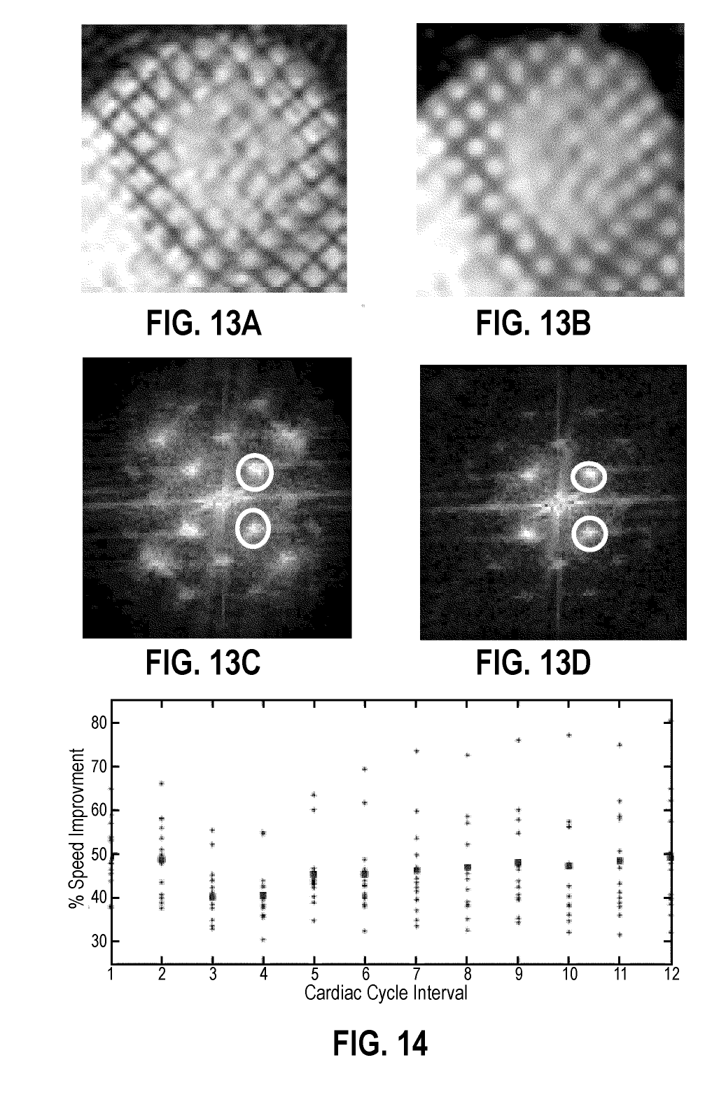

Furthermore, similar to the phantom data, the overall strain homogeneity of the image clearly increases in the example experiment. FIGS. 15A and 15B illustrate that continuous areas in an in-vivo image may be improved after processing. FIGS. 15A and 15B provide example data strain maps for in-vivo CMR images; FIG. 15A provides a data strain map for original CMR images, and FIG. 15B provides a data strain map after processing the CMR images of FIG. 15A. As illustrated, variability in strain within small neighborhoods is reduced in the example after processing, thereby providing more uniformity in a given vascular territory. Just as for the phantoms, the reduction of the strain variances, for the in-vivo data, is statistically significant, as shown in Table IV.

TABLE IV

| | Before Processing | After Processing |
|---|---|---|
| Mean Strain Variance | 0.0022 | 0.0017 |
| Standard deviation | 4.6E−4 | 3.6E−4 |

| | |
|---|---|
| P-value | <1E−4 |

### Computational Efficiency

The total processing time of a HARP analysis may be only slightly increased using embodiments of the invention because faster analysis of the restored images typically compensates for the extra image restoration time. The average processing time required for processing one 256×256 DICOM image was 9.4±0.2 seconds, i.e. about 145 seconds in average for a typical data set of 15 CMR images. Unlike other alternatives, embodiments of the invention may not require any user input or prior knowledge of model templates: all the parameters may be automatically learned from a given data set. This reduces the overall data analysis time and makes the analysis more robust due to elimination of possible human errors.

### Conclusion

Spectral domain techniques, such as HARP, may be more efficient as compared to other methods for processing tagged MR images, such as to compute cardiac strain as the indicator of cardiac function. The experimental results discussed above indicate that the proposed processing of the tagged CMR images in the spatiotemporal domain may contribute to data de-noising and may improve the subsequent analysis in the spectral domain.

The first-order (LCDG) and second-order (MGRF) probabilistic modeling of the tagged MR images may exploit both the current spatial neighborhood information, and a prior and future temporal cardiac cycle information, to thereby improve spectral main-to-side-lobe ratio, which characterizes the noise reduction in the image spectra. Embodiments of the invention improve strain homogeneity, indexed with the strain variance in the spatial image representations. Additionally, the estimation of strain slopes, being an important clinical index of strain curves, may be improved by the noise reduction in the spectral domain. Overall, this reduces the high-spectral-noise-related errors in tracking material points between successive temporal frames, as the heart progresses through the cardiac cycle.

While embodiments of the invention have been described with respect to the HARP analysis of tagged heart CMR images, some embodiments of the invention may have a wide range of applications for de-noising image spectra and motion tracking in the spectral domain, particularly in other medical and non-medical image analysis applications involving spectral tracking of points where the images incorporate grids or grid-like image elements, tracking road intersections in moving or stationary images, tracking intersections of linear structures in an image using spectral analysis, etc. Unlike many of the other known techniques, subsequent spectral algorithms, such as the HARP, need no modification to underlying algorithms. Images processed by embodiments of the invention may ensure more efficient and robust estimates of functional parameters with state-of-the-art tools for spectral image analysis. For example, some embodiments of the invention may lead to more accurate clinical cardiac measurements and evaluations, while such embodiments may add only a very small amount of time to conventional HARP image analysis. For example, as indicated in some experimental data for some embodiments, the ratio between the mean spectral power in the main lobe and the side lobes of the image spectral representations, which relates inversely to the level of spectral noise, may increased by approximately 265% for an improved noisy phantom and approximately 46% for the improved real data. Thus, by reducing the spectral noise, some embodiments may improve both the strain slope estimation and the regional strain homogeneity. Thereby, the embodiments may provide improved CMR images, thereby providing clinicians with more accurate image functional data to make judgments for the individual patient.

Additional benefits may include an ability to be used in a modular manner, such that images are improved directly, and allowing for integration with existing systems as an “addon” to the system, and without requiring modification of commercial spectral tracking code. In addition, in many embodiments, no user input or prior knowledge of model templates is required, and all the parameters may be automatically learned from a given data set, which reduces the overall data analysis time and makes the analysis more robust due to elimination of possible human errors.

Other modifications will be apparent to one of ordinary skill in the art. Therefore, the invention lies in the claims hereinafter appended.

What is claimed is:

1. A method of processing medical images, the method comprising:
receiving tagged cardiac magnetic resonance (CMR) image data including signals associated with tags of the image data and background of the image data;
generating a three dimensional (3D) spatiotemporal model based on the cardiac magnetic resonance image data;
analyzing the 3D model using a linear combination of discrete Gaussians model to determine a discriminant threshold for classifying signals of the CMR images as associated with a tag or background;
analyzing the 3D model using a Markov-Gibbs random field model to determine a Gibbs energy function for the cardiac magnetic resonance image data; and
adjusting the signals of the cardiac magnetic resonance image data based on the Gibbs energy function and the discriminant threshold.

2. A method for processing a tagged magnetic resonance image, the method comprising:
receiving a plurality of magnetic resonance images associated with different time slices of a cardiac cycle, wherein each magnetic resonance image includes a plurality of tags, and wherein each magnetic resonance image includes a plurality of pixels, each pixel including an associated gray level value;
generating a spatiotemporal three dimensional (3D) model based on the magnetic resonance images including a plurality of voxels based on the pixels of the magnetic resonance images, wherein each voxel includes an associated gray level based on the gray levels of the pixels, and wherein each voxel corresponds with a tag or background;
analyzing the voxels of the 3D model using a first order model and a second order model to classify each voxel as corresponding to a tag or background;
adjusting the gray level associated with each voxel based on the classification of the voxel; and
deconstructing the 3D model into processed tagged magnetic resonance images, wherein the gray level values of each pixel is adjusted based on the adjusted gray level of the voxels.

3. The method of claim 2, wherein the first order model comprises a linear combination of discrete Gaussians model, wherein analyzing the voxels of the 3D model includes determining a discriminant threshold to classify the voxels as associated with a tag or background.

4. The method of claim 3, wherein analyzing the voxels of the 3D model includes partitioning the linear combination of discrete Gaussians model into tag and background submodels.

5. The method of claim 3, wherein the second order model comprises a Markov-Gibbs random field model, wherein analyzing the voxels of the 3D model includes determining a Gibbs energy function.

6. The method of claim 5, wherein analyzing the voxels of the 3D model includes:
generating the Markov-Gibbs random field model;
determining a Gibbs probability distribution;
generating a column vector including relative empirical frequencies of signals in the voxels and frequencies of absolute signal differences in voxel cliques; and
determining maximum likelihood approximations of Gibbs potentials for signals and signal differences.

7. The method of claim 3, wherein adjusting the gray level associated with each voxel includes adjusting the gray level by a bias determined from the discriminant threshold.

8. A method for enhancing a plurality of images for use in spectral tracking, the method comprising:
receiving image data for a plurality of images respectively associated with a plurality of times, wherein each image includes a plurality of pixels, each pixel including an associated gray level value;
generating a spatiotemporal three dimensional (3D) model based on the image data including a plurality of voxels based on the pixels of the images, wherein each voxel includes an associated gray level based on the gray levels of the pixels, wherein each voxel corresponds to one of a plurality of values of a parameter, and wherein a first dimension of the 3D model is a temporal dimension; and
classifying each voxel as corresponding to one of the plurality of values of the parameter based at least in part on a Markov-Gibbs random field model.

9. The method of claim 8, wherein classifying each voxel includes using the Markov-Gibbs random field model to determine a Gibbs energy function for the image data.

10. The method of claim 9, wherein using the Markov-Gibbs random field model to determine a Gibbs energy function for the image data includes:
generating the Markov-Gibbs random field model;
determining a Gibbs probability distribution;
generating a column vector including relative empirical frequencies of signals in the voxels and frequencies of absolute signal differences in voxel cliques; and
determining maximum likelihood approximations of Gibbs potentials for signals and signal differences.

11. The method of claim 9, wherein classifying each voxel includes using the Markov-Gibbs random field model to determine a gray level value for a voxel based at least in part on image data associated with past and future images.

12. The method of claim 11, further comprising analyzing the 3D model using a linear combination of discrete Gaussians model to determine a discriminant threshold.

13. The method of claim 12, wherein analyzing the 3D model includes partitioning the linear combination of discrete Gaussians model into tag and background submodels.

14. The method of claim 12, further comprising enhancing the image data based on the Gibbs energy function and the discriminant threshold.

15. The method of claim 8, wherein the image data comprises a plurality of magnetic resonance images associated with different time slices of a cardiac cycle, wherein each magnetic resonance image includes a plurality of tags, and wherein the plurality of values of the parameter includes a first value associated with a tag and a second value associated with a background such that classifying each voxel comprises classifying each voxel as either a tag or a background.

16. An apparatus, comprising:
at least one processor; and
program code configured upon execution by the at least one processor to process a tagged magnetic resonance image by:
receiving a plurality of magnetic resonance images associated with different time slices of a cardiac cycle, wherein each magnetic resonance image includes a plurality of tags, and wherein each magnetic resonance image includes a plurality of pixels, each pixel including an associated gray level value;
generating a spatiotemporal three dimensional (3D) model based on the magnetic resonance images including a plurality of voxels based on the pixels of the magnetic resonance images, wherein each voxel includes an associated gray level based on the gray levels of the pixels, and wherein each voxel corresponds with a tag or background;
analyzing the voxels of the 3D model using a first order model and a second order model to classify each voxel as corresponding to a tag or background;
adjusting the gray level associated with each voxel based on the classification of the voxel; and
deconstructing the 3D model into processed tagged magnetic resonance images, wherein the gray level values of each pixel is adjusted based on the adjusted gray level of the voxels.

17. The apparatus of claim 16, wherein the first order model comprises a linear combination of discrete Gaussians model, wherein the program code is configured to analyze the voxels of the 3D model by determining a discriminant threshold to classify the voxels as associated with a tag or background.

18. The apparatus of claim 17, wherein the second order model comprises a Markov-Gibbs random field model, wherein the program code is configured to analyze the voxels of the 3D model by determining a Gibbs energy function.

19. The apparatus of claim 17, wherein the program code is configured to adjust the gray level associated with each voxel by adjusting the gray level by a bias determined from the discriminant threshold.

20. A program product, comprising:
a computer readable medium; and
program code stored on the computer readable medium and configured upon execution by at least one processor process a tagged magnetic resonance image by:
receiving a plurality of magnetic resonance images associated with different time slices of a cardiac cycle, wherein each magnetic resonance image includes a plurality of tags, and wherein each magnetic resonance image includes a plurality of pixels, each pixel including an associated gray level value;
generating a spatiotemporal three dimensional (3D) model based on the magnetic resonance images including a plurality of voxels based on the pixels of the magnetic resonance images, wherein each voxel includes an associated gray level based on the gray levels of the pixels, and wherein each voxel corresponds with a tag or background;
analyzing the voxels of the 3D model using a first order model and a second order model to classify each voxel as corresponding to a tag or background;
adjusting the gray level associated with each voxel based on the classification of the voxel; and
deconstructing the 3D model into processed tagged magnetic resonance images, wherein the gray level values of each pixel is adjusted based on the adjusted gray level of the voxels.
